(19) United States
(12) Patent Application Publication
(10) Pub. No.: US 2003/0052016 A1
(43) Pub. Date: Mar. 20, 2003

(54) Method and system for controlling the temperature of an oxygen sensor

(76) Inventors: Yingjie Lin, El Paso, TX (US); Da Yu Wang, Troy, MI (US); Eric Detwiler, Davison, MI (US); Paul Kikuchi, Fenton, MI (US)

Correspondence Address: VINCENT A. CICHOSZ, DELPHI TECHNOLOGIES, INC., Legal Staff, Mail Code, 480-414-420, P.O. Box 5052, Troy, MI, 48007-5052, US

(21) Appl. No.: 09/954,887

(22) Filed: Sep. 18, 2001

(51) Int. Cl. G01N 27/407

(52) U.S. Cl. 205/785; 204/408; 204/424

(57) ABSTRACT

A method and system for controlling the temperature of an oxygen sensor is provided wherein the method includes obtaining an oxygen sensor, a heating device, heating control device and a signal generator, wherein the oxygen sensor includes a reference cell and wherein the heating device is communicated with the oxygen sensor and the heating control device, introducing a fixed frequency sinusoidal signal to the reference cell through a voltage divider resistor so as to create a response signal, wherein the response signal is responsive to the temperature of the reference cell, buffering the response signal so as to create a buffered signal, applying the buffered signal to a high pass filter so as to create a filtered signal having a filtered signal magnitude, wherein the filtered signal magnitude is inversely proportional to the temperature of the reference cell, measuring the filtered signal so as to create a temperature signal responsive to the filtered signal magnitude and communicating the temperature signal to the heating control device.

### BACKGROUND

Due to its direct impact on engine emission and engine efficiency, the air-to-fuel mixture ratio is one of the most important operational parameters for combustion engine control. A combustion engine normally includes an oxygen sensor and an engine control module, wherein the oxygen sensor is communicated with the engine control module so as to form a closed loop control system. The oxygen sensor is usually located in the exhaust of a combustion engine so as to be exposed to the exhaust gases created when the engine is operated. The oxygen sensor measures the equilibrium oxygen concentration in the exhaust gases and communicates this information back to the engine control module which then adjusts the combustion engine controls in order to achieve a desired air-to-fuel mixture ratio. Although there are many types of oxygen sensors available, a new generation of oxygen sensors have been created and are being utilized on an increasing basis. This new oxygen sensor is referred to as a wide range or linear oxygen sensor.

Typically, the linear oxygen sensor has a sensor control, an oxygen pump and a reference cell, wherein the reference cell typically includes a diffusion room where exhaust gas is allowed to build up. A DC voltage potential is allowed to build up across the reference cell and is proportional to the oxygen concentration difference between the exhaust gas inside the diffusion room and the air outside of the exhaust. In order to keep the voltage potential across the reference cell at a constant voltage potential, the oxygen level within the diffusion room is increased or decreased via the oxygen pump which is controlled by the sensor control. As a result, the current drawn by the oxygen pump is proportional to the oxygen concentration difference between the exhaust gas and the air outside of the exhaust.

Moreover, because of the physical and operating characteristics of the linear oxygen sensor, the operating temperature of the oxygen sensor should be kept within a temperature range of 500 to 800 degrees Celsius. If the operating temperature of the oxygen sensor is not kept within this range, the oxygen sensor will not function properly or accurately. Therefore, the temperature measurement and temperature control become key elements in controlling the operation of the oxygen sensor. Typically, the temperature of the oxygen sensor is measured and adjusted, via a heater and a temperature feedback device, so as to remain as constant as possible within the above mention desired temperature range. Current methods of oxygen sensor temperature measurement are discussed below.

One way that the oxygen sensor temperature can be measured is by using the resistance of the heater as the temperature sensor. However, this method is not very efficient or reliable because as the temperature changes, the resistance of the heater's electrical leads change.

Another way, and the most popular way, to measure the temperature of the oxygen sensor, is to use the impedance of the reference cell as the temperature sensing element and to apply a current interruption method to measure the reference cell resistance. For a high frequency input, the reference cell resistance dominates the reference cell impedance and the reference cell resistance becomes a function of reference cell temperature. Using the current interruption method, a known voltage step function is applied to the reference cell and the current through the reference cell is measured. Because the boundary capacitance of the reference cell is relatively large, the sudden change of voltage causes a sudden change of current. This sudden change of current results in a current spike and the reference cell resistance can be determined from this current spike.

However, this method is problematic in a couple of ways. First, because of the high slew rate the current sampling time becomes very critical and even a small variation in sampling time results in a large variation in measurement. This helps to produce an unstable result having a low degree of repeatability. Second, during the current interruption period the operation of the oxygen sensor also needs to be interrupted. Because of this the oxygen sensor is not being operated to its full capacity.

Therefore, it is considered advantageous to provide a method for controlling the temperature of an oxygen sensor wherein a stable, highly repeatable measurement result can be obtained without interrupting the operation of the oxygen sensor. It is considered to be further advantageous to provide a method for controlling the temperature of an oxygen sensor wherein the algorithm and method could be applied to a wide variety of oxygen sensors.

### BRIEF SUMMARY

A method for controlling the temperature of an oxygen sensor comprising obtaining an oxygen sensor, a heating device, heating control device and a signal generator, wherein the oxygen sensor includes a reference cell and wherein the heating device is communicated with the oxygen sensor and the heating control device; introducing a fixed frequency sinusoidal signal to the reference cell through a voltage divider resistor so as to create a response signal, wherein the response signal is responsive to the temperature of the reference cell; buffering the response signal so as to create a buffered signal; applying the buffered signal to a high pass filter so as to create a filtered signal having a filtered signal magnitude, wherein the filtered signal magnitude is inversely proportional to the temperature of the reference cell; measuring the filtered signal so as to create a temperature signal responsive to the filtered signal magnitude; and communicating the temperature signal to the heating control device.

A medium encoded with a machine-readable computer program code for controlling the temperature of an oxygen sensor, the medium including instructions for causing controller to implement the aforementioned method.

### BRIEF DESCRIPTION OF THE DRAWINGS

The present invention will now be described, by way of an example, with references to the accompanying drawings, wherein like elements are numbered alike in the several figures in which:

FIG. 1 shows a flow chart describing a method for controlling the temperature of an oxygen sensor in accordance with an embodiment of the invention;

FIG. 2 is a block diagram of a system for controlling the temperature of an oxygen sensor in accordance with an embodiment of the invention; and

FIG. 3 shows an oxygen sensor disposed within the exhaust pipe of a combustion engine in accordance with an embodiment of the invention.

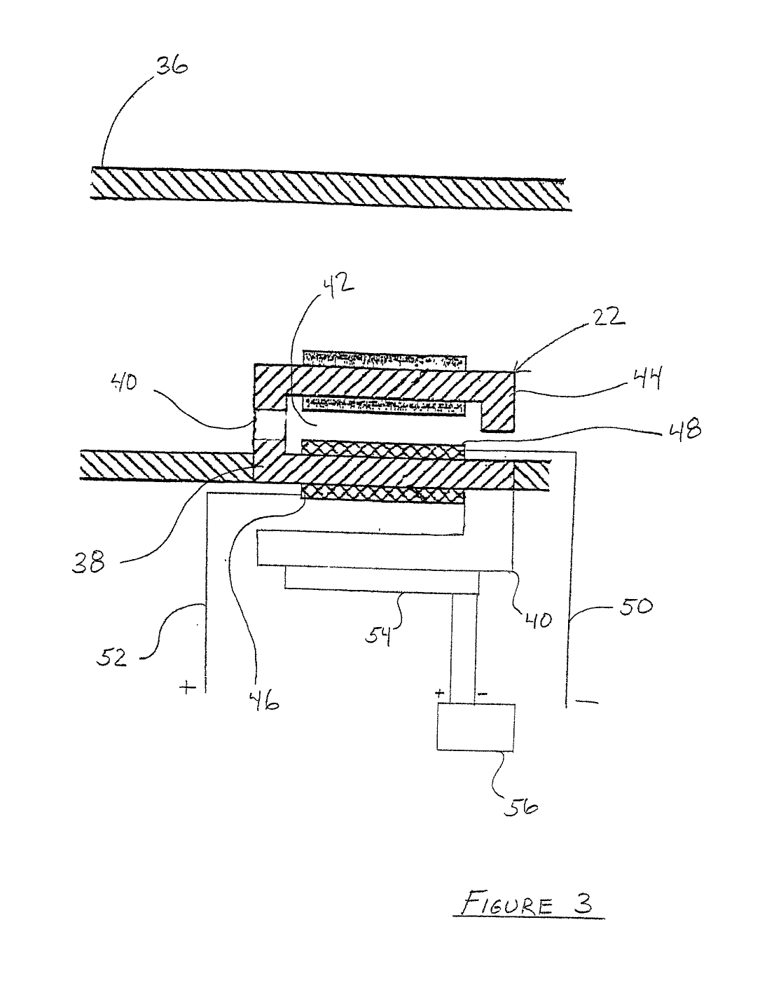

### DETAILED DESCRIPTION OF AN EXEMPLARY EMBODIMENT

An exemplary embodiment is described herein by way of illustration as may be applied to a vehicle and more specifically a vehicle having a combustion engine. While a preferred embodiment is shown and described, it will be appreciated by those skilled in the art that the invention is not limited to the embodiment and application described herein, but also to any vehicle or device which employs a combustion engine or any system which employs a combustion engine where an oxygen sensor feedback is desired, such as a generator. Those skilled in the art will appreciate that a variety of potential implementations and configurations are possible within the scope of the disclosed embodiments.

Referring to the Figures, a method for controlling the temperature of an oxygen sensor is illustrated and discussed. In accordance with an embodiment of the invention, a oxygen sensor 22, a heating device 54, a heating control device 56 and a signal generator 14 are obtained as shown in step 2. Linear oxygen sensor 22 preferably includes an insulation layer 40, an oxygen pump 44, a diffusion room 42 and a reference cell 38. In accordance with an embodiment of the invention, reference cell 38 preferably includes a positive electrode 46 having a positive lead 52, a negative electrode 48 having a negative lead 50 and is disposed relative to oxygen pump 44 so as to be separated by diffusion room 42. In addition, oxygen sensor 22 is preferably disposed within a combustion engine exhaust pipe 36 so as to be exposed to exhaust gases.

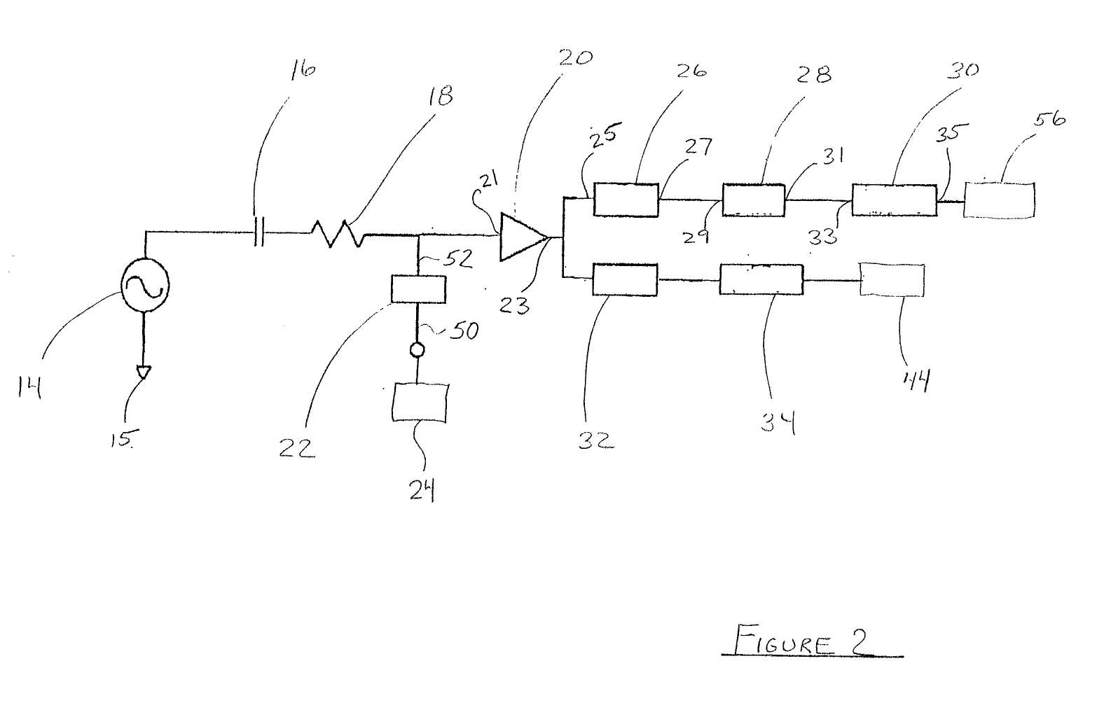

FIG. 2 depicts a system for controlling the temperature of oxygen sensor 22. The system includes a signal capacitor 16, a voltage divider resistor 18, a signal buffering circuit 20 having a buffer input 21 and a buffer output 23, a high pass filter 26 having a filter input 25 and a filter output 27, a AC amplitude to DC converter 28 having a detect input 29 and a detect output 31 and a signal amplifier 30 having an amplifier input 33 and an amplifier output 35. In accordance with an embodiment of the invention, signal generator 14 is preferably communicated with a ground potential 15 and with voltage divider resistor 18 through signal capacitor 16. Voltage divider resistor 18 is also preferably communicated with buffer input 21 and reference cell 38 via positive lead 52. Buffer output 23 is in turn communicated with filter input 25 and filter output 27 is preferably communicated with detect input 29. Detect output 31 is preferably communicated with amplifier input 33 and amplifier output 35 is communicated with heating control device 56.

A fixed frequency sinusoidal signal is then introduced to reference cell 38 so as to create a response signal responsive to the temperature of reference cell 38 as in step 4. In accordance with an embodiment of the invention, the sinusoidal signal is preferably a fixed frequency sinusoidal signal having a peak-to-peak voltage potential range between 0.2 volt and 0.8 volt. The sinusoidal signal is preferably serially introduced to reference cell 38 via positive lead 52 in a continuous fashion using signal generator 14 through signal capacitor 16 and voltage divider resistor 18. Also, in accordance with an embodiment of the invention, signal generator 14, signal buffering circuit 20, high pass filter 26, AC amplitude to DC converter 28 and signal amplifier 30 are powered by a constant reference voltage potential 24. In addition, a constant voltage potential 24 equal to one half of the constant reference voltage potential which is used to power the whole signal conditioning circuit, as described hereinabove, is applied to negative lead 50.

As the sinusoidal signal is applied to reference cell 38 the introduced sinusoidal signal is added to the reference cell 38, so as to be superimposed on top of the normal function of the reference cell 38. The AC magnitude of the applied sinusoidal signal at positive lead 52 will respond in an inversely proportional manner to the temperature of the reference cell 38. As the temperature of the reference cell 38 increases, the impedance of the reference cell 38 decreases causing the AC voltage potential magnitude at the positive lead 52 to decrease. This is because, at any given frequency, the complex impedance of the solid electrolyte construction of reference cell 38 can be represented in polar coordinates as:

Z*=Z₀(T,f)exp[iθ(T,f)],

Where, T is the temperature of reference cell 38, f is the applied sinusoidal signal frequency, and

Z₀{[R₀(1+A²)+R]²+A²R²}^{1/2}/(1+A²);

θ=tan⁻¹{AR/[R₀(1+A²)+R]}; and

A=2πfCR,

Where, C is the grain boundary capacitance which is constant with temperature, R₀ is the grain and R is the grain boundary resistance. In addition, R₀ and R are Arrhenius equations having activation energy's close to each other. Because of this, Z₀(T,f) is a monotonic function of the temperature of reference cell 38 at any fixed frequency f.

In accordance with an embodiment of the invention, the fixed frequency sinusoidal signal may be of any frequency suitable to the desired end purpose. Referring to the polar equation hereinabove, the frequency of the sinusoidal signal should be chosen such that the complex phase angle θ is lowest at the highest temperature value of a desired temperature range. It should be recognized that two constraints exist regarding the selection of the frequency of the sinusoidal signal. The first constraint is that if the frequency of the signal is too high, the control sensitivity of the response signal will be impeded. The second constraint is that if the frequency is too low, the impedance of the positive electrode 46 and the impedance of the negative electrode 48 will be included with the reference cell impedance. This is undesirable because the electrode impedances are a function of the ambient gas composition and will influence the control of the sensor temperature.

The response signal, seen at positive lead 52, is then buffered using a signal buffering circuit 20 so as to create a buffered signal, as in step 6. By applying the response signal to the buffer input 21, a conditioned, or buffered signal is created wherein the buffered signal is isolated from the response signal. In accordance with an embodiment of the invention, the buffered signal includes a high frequency signal component and a low frequency signal component wherein the high frequency signal component is responsive to the temperature of reference cell 38 and the low frequency signal component is used as the feedback control signal to oxygen pump 44.

The buffered signal is then applied to high pass filter 26, so as to filter out the low frequency signal component and create a filtered signal having a filtered signal magnitude as in step 8. This filtered signal is the isolated AC portion of the buffered signal and the filtered signal magnitude is responsive to the temperature of the reference cell 38. In accordance with an embodiment of the invention, the filtered signal magnitude is inversely proportional to the temperature of reference cell 38.

The filtered signal is then applied to detect input 29 of AC amplitude to DC converter 28 so as to convert the AC signal into a DC signal and create a temperature signal at detect output 31 responsive to the magnitude of the filtered signal as shown in step 10. The temperature signal at detect output 31 is then applied to a signal amplifier 30 so as to cause the temperature signal to be amplified. The amplified temperature signal at amplifier output 35 is then communicated to the heating control device 56 so as to cause the heating device 54 to respond to the temperature signal as shown in step 12.

In addition, as is well known in the art, the buffered signal is applied to a low pass filter 32, so as to filter out the high frequency signal component. The output from low pass filter 32 is then applied to a DC amplifier 34 so as to create a feedback control signal which is used to control oxygen pump 44.

In accordance with an embodiment of the invention, voltage divider resistor 18 is preferably a 50 ohm to 500 ohm resistor. However, voltage divider resistor 18 may be of any resistor value known in the art and suitable to the desired end purpose.

In accordance with an embodiment of the invention, constant reference voltage potential 24 may be supplied using any constant reference voltage potential source or power supplying device or circuitry capable of supplying a constant voltage that is known in the art and suitable to the desired end purpose.

In accordance with an embodiment of the invention, buffering circuit 20 may be any buffering circuit known in the art and suitable to the desired end purpose.

In accordance with an embodiment of the invention, high pass filter 26, may be any high pass filtering device or high pass filtering circuit known in the art and suitable to the desired end purpose.

In accordance with an embodiment of the invention, AC amplitude to DC converter 28 may be any device or circuit capable of converting an AC amplitude signal to a DC signal known in the art and suitable to the desired end purpose.

In accordance with an embodiment of the invention, signal amplifier 30, may be any signal amplifier known in the art and suitable to the desired end purpose.

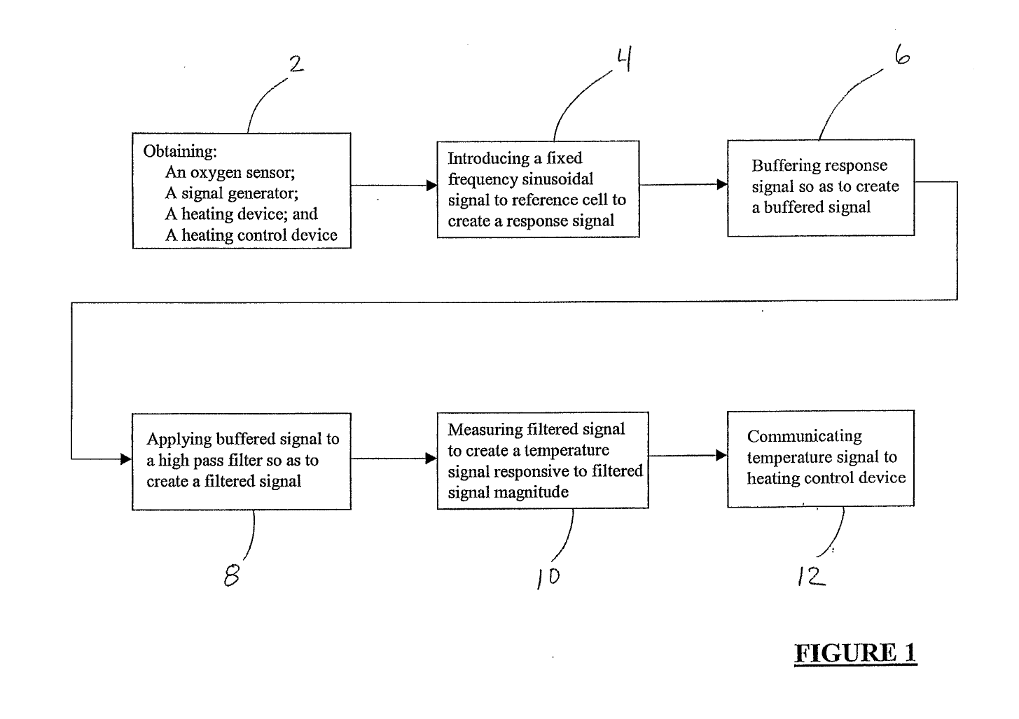

Processing of FIG. 1 may be implemented through a controller operating in response to a computer program. In order to perform the prescribed functions and desired processing, as well as the computations therefore (e.g., the execution of voltage mode motor control algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include signal input signal filtering to enable accurate sampling and conversion or acquisitions of such signals from communications interfaces.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for controlling the temperature of an oxygen sensor comprising:
obtaining an oxygen sensor, a heating device, heating control device and a signal generator, wherein said oxygen sensor includes a reference cell and wherein said heating device is communicated with said oxygen sensor and said heating control device;
introducing a fixed frequency sinusoidal signal to said reference cell through a voltage divider resistor so as to create a response signal, wherein
said response signal is responsive to the temperature of said reference cell;
buffering said response signal so as to create a buffered signal;
applying said buffered signal to a high pass filter so as to create a filtered signal having a filtered signal magnitude, wherein said filtered signal magnitude is inversely proportional to the temperature of said reference cell;
measuring said filtered signal so as to create a temperature signal responsive to said filtered signal magnitude; and
communicating said temperature signal to said heating control device.

2. The method of claim 1, further comprising obtaining a constant reference voltage potential and a signal buffering circuit, wherein said constant reference voltage potential and said signal buffering circuit are communicated with said reference cell.

3. The method of claim 2, further comprising a high pass filter, an AC amplitude to DC converter and a signal amplifier, wherein said high pass filter is communicated with said signal buffering circuit and said AC amplitude to DC converter and wherein said signal amplifier is communicated with said AC amplitude to DC converter and said heating control device.

4. The method of claim 1, wherein said heating control device is responsive to said temperature signal.

5. The method of claim 1, wherein said voltage divider resistor is disposed so as to be communicated in series with said fixed frequency signal generator through a signal capacitor and wherein said voltage divider resistor is disposed so as to be communicated in series said reference cell.

6. The method of claim 1, wherein said voltage divider resistor has a resistance between 50 ohms and 500 ohms.

7. The method of claim 1, wherein said introducing a fixed frequency sinusoidal signal includes continuously introducing said fixed frequency sinusoidal signal to said reference cell through said voltage divider resistor via said signal generator.

8. The method of claim 1, wherein said introducing a fixed frequency sinusoidal signal includes determining said fixed frequency sinusoidal signal such that the complex phase angle θ of said response signal is lowest at the highest temperature value of a desired temperature range.

9. The method of claim 1, wherein said introducing a fixed frequency sinusoidal signal includes introducing said fixed frequency sinusoidal signal having a peak-to-peak voltage between 0.2 volt to 0.8 volt.

10. The method of claim 1, wherein said buffering said response signal includes applying said response signal to a signal buffering circuit.

11. The method of claim 1, wherein said applying said buffered signal to a high pass filter includes applying said buffered signal to said high pass filter so as to isolate the DC portion of said response signal.

12. The method of claim 1, wherein said measuring said filtered signal includes applying said filtered signal to an AC amplitude to DC converter so as to determine said filtered signal magnitude.

13. The method of claim 1, wherein said measuring said filtered signal includes applying said temperature signal to a signal amplifier so as to increase the strength of said temperature signal.

14. The method of claim 1, wherein said communicating said temperature signal includes communicating said temperature signal to said heating control device so as to cause said heating device to respond.

15. A system for controlling the temperature of an oxygen sensor comprising:
an oxygen sensor, wherein said oxygen sensor includes a reference cell;
a constant reference voltage potential source, wherein said constant reference voltage potential source is communicated with said reference cell;
a heating control device;
a heating device, wherein said heating device is communicated with said heating control device and said oxygen sensor;
a signal generator;
a voltage divider resistor, wherein said voltage divider resistor is serially communicated with said signal generator and said reference cell;
a high pass filter;
a signal buffering circuit, wherein said signal buffering circuit is communicated with said reference cell, said voltage divider resistor and said high pass filter; and
an AC amplitude to DC converter, wherein said AC amplitude to DC converter is communicated with said high pass filter.

16. The system of claim 15 further comprising a signal capacitor, wherein said signal capacitor is disposed so as to be serially communicated with said voltage divider resistor and said signal generator.

17. The system of claim 15, wherein said reference cell includes a positive electrode having a positive lead and a negative electrode having a negative lead and wherein said buffering circuit includes a buffer input and a buffer output, wherein said buffer input is communicated with said positive lead.

18. The system of claim 17, wherein said constant reference voltage potential source is communicated with said reference cell via said negative lead.

19. The system of claim 17, wherein said high pass filter includes a filter input and a filter output and wherein said AC amplitude to DC converter includes a detect input and a detect output, wherein said filter input is communicated with said buffer output and wherein said filter output is communicated with said detect input.

20. The system of claim 19, further comprising a signal amplifier having an amplifier input and an amplifier output, wherein said amplifier input is communicated with said detect output and wherein said amplifier output is communicated with said heating control device.

21. The system of claim 15, wherein said voltage divider resistor has a resistance between 50 ohms and 500 ohms.
